(19) United States
(12) Patent Application Publication
(10) Pub. No.: US 2014/0046573 A1
(43) Pub. Date: Feb. 13, 2014

(54) CONTROL DEVICE AND CONTROL METHOD FOR INTERNAL COMBUSTION ENGINE

(71) Applicants: Jun Maemura, Okazaki-shi (JP); Seiji Hirowatari, Toyota-shi (JP)

(72) Inventors: Jun Maemura, Okazaki-shi (JP); Seiji Hirowatari, Toyota-shi (JP)

(21) Appl. No.: 14/114,088

(22) PCT Filed: Apr. 26, 2012
(86) PCT No.: PCT/IB2012/000816

§ 371 Date: Oct. 25, 2013

(30) Foreign Application Priority Data
Apr. 28, 2011 (JP) 2011-101546

(51) Int. Cl. F02D 45/00

(52) U.S. Cl. CPC F02D 45/00
USPC 701/102

(57) ABSTRACT

An electronic control unit for an internal combustion engine that includes an engine-driven alternator diagnoses on the bases of an air-fuel ratio correction amount in air-fuel ratio feedback control whether a rich abnormality that the air-fuel ratio of air-fuel mixture is excessively rich is occurring in a fuel injection system. When the state of charge of a battery charged with electric power generated by the alternator is higher than or equal to a predetermined value, charging control for setting a voltage generated by the alternator at a voltage lower than a normal generated voltage is executed. When the state of charge of the battery is higher than or equal to the predetermined value, charging control for charging the battery at the voltage is prohibited when a degree of mixing of fuel in lubricating oil of the internal combustion engine is higher than or equal to a predetermined degree.

### BACKGROUND OF THE INVENTION

1. Field of the Invention

The invention relates to control devices and control methods that diagnoses on the basis of an air-fuel ratio correction amount in air-fuel ratio feedback control whether a rich abnormality that the air-fuel ratio of air-fuel mixture of an internal combustion engine is excessively rich is occurring in a fuel injection system.

2. Description of Related Art

In an internal combustion engine, air-fuel ratio feedback control is executed over the fuel injection amount in order to bring an actual air-fuel ratio into coincidence with a target air-fuel ratio (for example, stoichiometric air-fuel ratio). Here, when an abnormality of some kind occurs in a fuel injection system, such as a fuel injection valve, an actual injection amount that is the amount of fuel actually injected and supplied may significantly exceed a target injection amount. In this case, the actual air-fuel ratio is richer than the target air-fuel ratio, which may lead to deterioration, or the like, of exhaust gas property.

Then, for example, in the technique described in Japanese Patent Application Publication No. 2001-73853 (JP 2001-73853 A), an air-fuel ratio correction amount is monitored during air-fuel ratio feedback control. When the air-fuel ratio correction amount has excessively reduced, it is determined that the actual injection amount is unnecessarily larger than the target injection amount, and it is diagnosed that a rich abnormality that the air-fuel ratio of air-fuel mixture is excessively rich is occurring in the fuel injection system.

In addition, the internal combustion engine includes a positive crankcase ventilation system that is used to handle blowby gas leaked from the inside of a cylinder into a crankcase. In the positive crankcase ventilation system, fresh air is introduced from the outside of the crankcase, and the fresh air is circulated inside the crankcase and is then returned to an intake passage. Then, air-fuel mixture that contains blowby gas is burned in a combustion chamber to thereby handle blowby gas without emitting the blowby gas to the outside.

Incidentally, when the engine is cold, injected fuel is hard to be atomized, so part of injected fuel may be not subjected to burning but adhere to the inner peripheral surface of the cylinder, and may be mixed with lubricating oil adhering to the inner peripheral surface of the cylinder in order to lubricate an engine piston. Then, lubricating oil on the inner peripheral surface of the cylinder, diluted through mixing of fuel, is scraped as the engine piston moves up and down, and is returned to the crankcase.

Here, as the percentage of fuel mixed in lubricating oil, that is, the degree of mixing of fuel, increases, a large amount of fuel evaporates from the lubricating oil accordingly, so the concentration of fuel in blowby gas may increase considerably. Then, as the blowby gas is returned to the intake passage, the actual air-fuel ratio of air-fuel mixture becomes richer than the target air-fuel ratio because of the returned blowby gas, so the air-fuel ratio correction amount in air-fuel ratio feedback control excessively reduces. As a result, although no abnormality is occurring in the fuel injection system, it may be erroneously diagnosed that a rich abnormality is occurring.

Note that it is conceivable that, for example, the flow rate of fresh air is increased in the case of a high degree of mixing of fuel in lubricating oil to increase the percentage of fresh air in air-fuel mixture to thereby reduce the influence of blowby gas. By so doing, the width of reduction in air-fuel ratio correction amount in air-fuel ratio feedback control reduces. This suppresses an erroneous diagnosis that a rich abnormality is occurring. However, in this case, the engine rotation speed increases against a driver's intention, so the driver may experience a feeling of strangeness.

### SUMMARY OF THE INVENTION

The invention provides control devices and control methods for an internal combustion engine control that is able to suppress an erroneous diagnosis that a rich abnormality is occurring in a fuel injection system because of dilution of lubricating oil due to mixing of fuel while suppressing a feeling of strangeness experienced by a driver.

A first aspect of the invention relates to an internal combustion engine control device that is applied to an internal combustion engine that includes an engine-driven generator. The internal combustion engine control device includes: rich abnormality determining means for diagnosing on the basis of an air-fuel ratio correction amount in air-fuel ratio feedback control whether a rich abnormality that an air-fuel ratio of air-fuel mixture is excessively rich is occurring in a fuel injection system; power generation control means for setting a voltage generated by the generator so as to be higher when a degree of mixing of fuel in lubricating oil of the internal combustion engine is higher than or equal to a predetermined degree than when the degree of mixing of fuel is lower than the predetermined degree.

In the internal combustion engine, as the degree of mixing of fuel in the lubricating oil increases, the fuel concentration in blowby gas returned to the intake passage increases, and such blowby gas is returned to the intake passage to further enrich the air-fuel ratio of air-fuel mixture. In addition, the flow rate of blowby gas returned to the intake passage almost does not vary even when the flow rate of fresh air varies. With these facts, as the degree of mixing of fuel in the lubricating oil increases or as the flow rate of fresh air reduces, the percentage of blowby gas (particularly, fuel component) in air-fuel mixture increases, and an erroneous diagnosis that a rich abnormality is occurring in the fuel injection system tends to be made because of dilution of lubricating oil due to mixing of fuel.

According to the above aspect, the voltage generated by the generator is set so as to be higher when the degree of mixing of fuel in the lubricating oil is higher than or equal to the predetermined degree than when the degree of mixing of fuel is not higher than or equal to the predetermined degree. That is, the engine load is increased as the generator is driven when the probability of making an erroneous diagnosis that a rich abnormality is occurring because of the degree of mixing of fuel in the lubricating oil is high as compared with when the probability is low. By so doing, the flow rate of fresh air increases to increase the percentage of fresh air in air-fuel mixture, so the influence of blowby gas (particularly, fuel component) reduces. Here, in the configuration that the flow rate of fresh air is simply increased, engine output increases and the increased engine output is converted to an increase in the engine rotation speed, so the driver may experience a feeling of strangeness. However, according to the above aspect, even when engine output increases, the increased engine output is converted to electric power by driving the generator, so the driver is hard to experience a feeling of strangeness. Thus, while suppressing a feeling of strangeness experienced by the driver, it is possible to suppress an erroneous diagnosis that a rich abnormality is occurring in the fuel injection system because of dilution of lubricating oil due to mixing of fuel.

In the above aspect, the internal combustion engine control device may further include fuel mixing degree determining means for determining the degree of mixing of fuel in the lubricating oil of the internal combustion engine. The power generation control means may control the voltage generated by the generator at the time when rich abnormality determination is being carried out by the rich abnormality determining means.

In the above aspect, the power generation control means may execute charging control for setting the voltage generated by the generator at a voltage lower than a normal generated voltage when a state of charge of a battery charged with electric power generated by the generator is higher than or equal to a predetermined value, and the power generation control means may limit charging control for charging the battery at the voltage lower than the normal generated voltage when the state of charge of the battery is higher than or equal to the predetermined value and the degree of mixing of fuel is higher than or equal to the predetermined degree.

According to the above aspect, when the state of charge of the battery is higher than or equal to the predetermined value, the voltage generated by the generator is set at the voltage lower than the normal generated voltage. By so doing, the power generation load is reduced to reduce the engine load to thereby make it possible to save power consumption. However, if the charging control is executed in a normal mode until the degree of mixing of fuel in the lubricating oil is higher than or equal to the predetermined degree, the engine load is reduced to reduce the flow rate of fresh air, so the percentage of blowby gas (particularly, fuel component) in air-fuel mixture increases. Therefore, an erroneous diagnosis that a rich abnormality is occurring tends to be made.

In this respect, according to the above aspect, even when the state of charge of the battery is higher than or equal to the predetermined value, but when the degree of mixing of fuel is higher than or equal to the predetermined degree, charging control for charging the battery at the voltage lower than the normal generated voltage is limited. Therefore, the engine load is not reduced or the amount of reduction in power generation load is reduced to thereby suppress an increase in the percentage of blowby gas (particularly, fuel component) in air-fuel mixture. Thus, by adequately limiting charging control, it is possible to suppress an erroneous diagnosis that a rich abnormality is occurring.

In the above aspect, when the state of charge of the battery is higher than or equal to the predetermined value and the degree of mixing of fuel is higher than or equal to the predetermined degree, the power generation control means may prohibit charging control for charging the battery at the voltage lower than the normal generated voltage, and may set the voltage generated by the generator at a voltage higher than the normal generated voltage.

According to the above aspect, the power generation load is increased to increase the engine load, so the flow rate of fresh air increases, and the percentage of blowby gas (particularly, fuel component) in air-fuel mixture further reduces. Thus, it is possible to further suppress an erroneous diagnosis that a rich abnormality is occurring.

In the above aspect, the voltage higher than the normal generated voltage may be a maximum value within a range in which the voltage generated by the generator is settable.

According to the above aspect, the voltage generated by the generator is set at the maximum value within the settable range, so the power generation load is maximized to maximize the amount of increase in the engine load caused by driving the generator. By so doing, the percentage of blowby gas (particularly, fuel component) in air-fuel mixture further reduces. Thus, it is possible to further suppress an erroneous diagnosis that a rich abnormality is occurring.

In the above aspect, when the state of charge of the battery is higher than or equal to the predetermined value and the degree of mixing of fuel is higher than the predetermined degree, the power generation control means may prohibit charging control for charging the battery at the voltage lower than the normal generated voltage, and may set the voltage generated by the generator at the normal generated voltage.

In the above aspect, when the state of charge of the battery is higher than or equal to the predetermined value and the degree of mixing of fuel is higher than or equal to the predetermined degree, the power generation control means prohibit charging control for charging the battery at the voltage lower than the normal generated voltage, and may set the voltage generated by the generator at a voltage that is lower than the normal generated voltage and that is higher than the voltage lower than the normal generated voltage.

In the above aspect, on the condition that the internal combustion engine is in a predetermined low load operation, the power generation control means may set the voltage generated by the generator so as to be higher when the degree of mixing of fuel is higher than or equal to the predetermined degree than when the degree of mixing of fuel is lower than the predetermined degree.

According to the above aspect, only during low load operation in which an erroneous diagnosis that a rich abnormality is occurring in the fuel injection system because of dilution of lubricating oil due to mixing of fuel tends to be made, control at the generated voltage is executed by the power generation control means. Therefore, it is possible to suppress an erroneous diagnosis that the rich abnormality is occurring during low load operation. In addition, during high load operation, or the like, in which an erroneous diagnosis that the rich abnormality is occurring is hard to be made, the voltage generated by the generator is not set so as to be unnecessarily high. Thus, it is possible to suppress an unnecessary increase in power generation load caused by the generator.

In the above aspect, the internal combustion engine may be in the predetermined low load operation when the internal combustion engine is in idle operation.

In the above aspect, the internal combustion engine may be in the predetermined low load operation when an intake air flow rate of the internal combustion engine is smaller than or equal to a predetermined flow rate.

In the above aspect, when the degree of mixing of fuel in the lubricating oil of the internal combustion engine is higher than or equal to the predetermined degree, the power generation control means may set the voltage generated by the generator so as to be higher as the degree of mixing of fuel increases.

A second aspect of the invention relates to an internal combustion engine control device that is applied to an internal combustion engine that includes an engine-driven generator. The internal combustion engine control device includes: rich abnormality determining means for diagnosing on the basis of an air-fuel ratio correction amount in air-fuel ratio feedback control whether a rich abnormality that an air-fuel ratio of air-fuel mixture is excessively rich is occurring in a fuel injection system; power generation control means for setting, when a degree of mixing of fuel in lubricating oil of the internal combustion engine is higher than or equal to a predetermined degree, a voltage generated by the generator so as to be higher as the degree of mixing of fuel increases.

According to the above aspect, the voltage generated by the generator is set so as to be higher as the degree of mixing of fuel increases when the degree of mixing of fuel in the lubricating oil is higher than or equal to the predetermined degree. That is, as the probability of making an erroneous diagnosis that a rich abnormality is occurring because of the degree of mixing of fuel in the lubricating oil increases, the power generation load is increased to increase the engine load. By so doing, as the probability of making an erroneous diagnosis that the rich abnormality is occurring increases, the influence of blowby gas (particularly, fuel component) may be reduced. Here, in the configuration that the flow rate of fresh air is simply increased, engine output increases and the increased engine output is converted to an increase in the engine rotation speed, so the driver may experience a feeling of strangeness. However, according to the above aspect, even when engine output increases, the increased engine output is converted to electric power by driving the generator, so the driver is hard to experience a feeling of strangeness. Thus, while suppressing a feeling of strangeness experienced by the driver, it is possible to suppress an erroneous diagnosis that a rich abnormality is occurring in the fuel injection system because of dilution of lubricating oil due to mixing of fuel.

In the above aspect, the internal combustion engine control device may further include fuel mixing degree determining means for determining the degree of mixing of fuel in the lubricating oil of the internal combustion engine. The power generation control means may control the voltage generated by the generator at the time when rich abnormality determination is being carried out by the rich abnormality determining means.

In the above aspect, on the condition that the internal combustion engine is in a predetermined low load operation, the power generation control means may set the voltage generated by the generator so as to be higher as the degree of mixing of fuel increases when the degree of mixing of fuel is higher than or equal to the predetermined degree.

In the above aspect, the internal combustion engine may be in the predetermined low load operation when the internal combustion engine is in idle operation.

In the above aspect, the internal combustion engine may be in the predetermined low load operation when an intake air flow rate of the internal combustion engine is smaller than or equal to a predetermined flow rate.

In the first and second aspects, the voltage generated by the generator may be set through feedforward control.

In this case, the voltage generated by the generator may be easily set at a predetermined value.

A third aspect of the invention relates to an internal combustion engine control method that is applied to an internal combustion engine that includes an engine-driven generator. The internal combustion engine control method includes: diagnosing on the basis of an air-fuel ratio correction amount in air-fuel ratio feedback control whether a rich abnormality that an air-fuel ratio of air-fuel mixture is excessively rich is occurring in a fuel injection system; determining a degree of mixing of fuel in lubricating oil of the internal combustion engine; and setting, at the time when rich abnormality determination is being carried out, a voltage generated by the generator so as to be higher when the degree of mixing of fuel is higher than or equal to a predetermined degree than when the degree of mixing of fuel is lower than the predetermined degree.

A fourth aspect of the invention relates to an internal combustion engine control method that is applied to an internal combustion engine that includes an engine-driven generator. The internal combustion engine control method includes: diagnosing on the basis of an air-fuel ratio correction amount in air-fuel ratio feedback control whether a rich abnormality that an air-fuel ratio of air-fuel mixture is excessively rich is occurring in a fuel injection system; determining a degree of mixing of fuel in lubricating oil of the internal combustion engine; and setting, at the time when rich abnormality determination is being carried out, a voltage generated by the generator so as to be higher as the degree of mixing of fuel increases, when the degree of mixing of fuel is higher than or equal to a predetermined degree.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view that shows the schematic configuration of a vehicle-mounted internal combustion engine to which an internal combustion engine control device according to a first embodiment of the invention is applied;

FIG. 2 is a flow chart that shows the procedure of the process of setting a voltage generated by an alternator in the first embodiment;

FIG. 3 is a timing chart that shows examples of changes of whether there is a request to decrease the voltage generated by the alternator, the degree of mixing of fuel in lubricating oil, a signal output from an idle switch and the voltage generated by the alternator together;

FIG. 4 is a flow chart that shows the procedure of the process of setting a voltage generated by an alternator, executed by an internal combustion engine control device according to a second embodiment of the invention;

FIG. 5 is a timing chart that shows examples of changes of whether there is a request to decrease the voltage generated by the alternator, the degree of mixing of fuel in lubricating oil, the intake air flow rate and the voltage generated by the alternator together; and

FIG. 6 is a graph that shows the correlation between the degree of mixing of fuel in lubricating oil and the voltage generated by the alternator in an internal combustion engine control device according to an alternative embodiment of the invention.

### DETAILED DESCRIPTION OF EMBODIMENTS

### First Embodiment

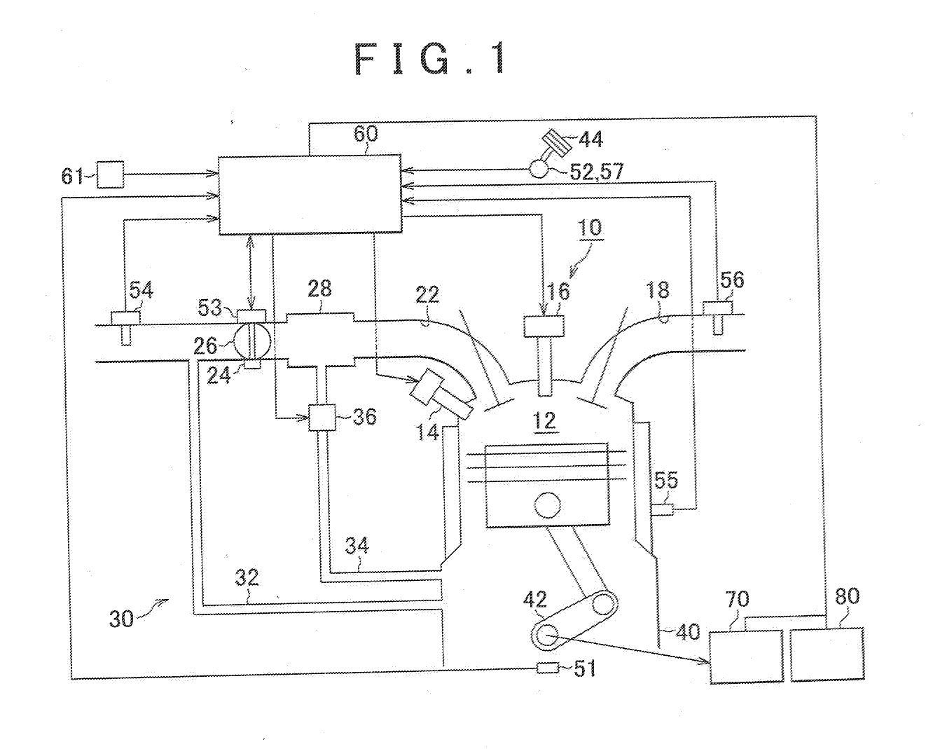

A specific first embodiment of an internal combustion engine control device according to the aspect of the invention will be described with reference to FIG. 1 to FIG. 3. Note that an internal combustion engine according to the present embodiment is a vehicle-mounted internal combustion engine (hereinafter, internal combustion engine) 10 that directly injects fuel into a cylinder.

FIG. 1 shows the schematic configuration of the internal combustion engine 10 according to the present embodiment. An intake passage 22 and an exhaust passage 18 are connected to a combustion chamber 12 of the internal combustion engine 10.

A throttle valve 26 is provided in the intake passage 22. The throttle valve 26 is actuated by a throttle motor 24 to open or close. In addition, a surge tank 28 is provided on the intake air downstream side of the throttle valve 26 in the intake passage 22. Then, the opening degree of the throttle valve 26 is changed to adjust the flow rate of intake air (fresh air) supplied to the combustion chamber 12.

A fuel injection valve 14 is provided for the internal combustion engine 10. The fuel injection valve 14 directly injects fuel into the cylinder (combustion chamber 12). In addition, an ignition plug 16 is provided for the internal combustion engine 10. The ignition plug 16 ignites air-fuel mixture produced by mixing fuel injected from the fuel injection valve 14 with intake air taken into the cylinder via the intake passage 22.

A catalyst device (not shown) is provided in the exhaust passage 18. The catalyst device is used to purify exhaust gas. A positive crankcase ventilation system 30 is provided for the internal combustion engine 10. The positive crankcase ventilation system 30 is used to return blowby gas in the crankcase 40 to the intake passage 22 and then handle the returned blowby gas. The positive crankcase ventilation system 30 includes an introducing passage 32 and a return passage 34. The introducing passage 32 connects the intake air upstream side of the throttle valve 26 in the intake passage 22 with the inside of the crankcase 40. The return passage 34 connects the intake air downstream side of the throttle valve 26 in the intake passage 22 with the inside of the crankcase 40. A PCV valve 36 is provided in the middle of the return passage 34. The PCV valve 36 adjusts the flow rate of blowby gas returned from the crankcase 40 to the intake passage 22. Note that the PCV valve 36 in the present embodiment is of a mechanical type (spring type).

In the internal combustion engine 10 that includes the above described positive crankcase ventilation system 30, fresh air is introduced into the crankcase 40 via the introducing passage 32, and the fresh air is circulated inside the crankcase 40 and is then returned to the intake passage 22 via the return passage 34. Then, air-fuel mixture that contains blowby gas burns in the combustion chamber 12 to thereby handle blowby gas without emitting the blowby gas outside.

In addition, an engine-driven alternator 70 is provided for the internal combustion engine 10. The alternator 70 serves as a generator. The alternator 70 is driven by a crankshaft 42 to generate electric power. The crankshaft 42 is the output shaft of the internal combustion engine 10. A battery 80 is charged with the generated electric power.

In addition, various sensors for detecting the operating state of the internal combustion engine 10 are provided for the internal combustion engine 10. The various sensors include an engine rotation speed sensor 51, an accelerator operation amount sensor 52 and an idle switch 57. The engine rotation speed sensor 51 detects the engine rotation speed NE that is the rotation speed of the crankshaft 42. The accelerator operation amount sensor 52 detects the accelerator operation amount ACCP that is the operation amount of an accelerator pedal 44. The idle switch 57 detects whether the accelerator pedal 44 is operated. In addition, the various sensors further include a throttle opening degree sensor 53 and an intake air flow rate sensor 54. The throttle opening degree sensor 53 detects the throttle opening degree TA that is the opening degree of the throttle valve 26. The intake air flow rate sensor 54 detects the intake air flow rate GA that is the flow rate of intake air passing through the throttle valve 26. Furthermore, the various sensors include a coolant temperature sensor 55 and an air-fuel ratio sensor 56. The coolant temperature sensor 55 detects the coolant temperature THW that is the temperature of engine coolant. The air-fuel ratio sensor 56 detects the air-fuel ratio of exhaust gas. Detected signals of these sensors 51 to 57 are input to an electronic control unit 60 that executes various controls over the internal combustion engine 10. Supply and stop of current to the electronic control unit 60 and operation and stop of the internal combustion engine 10 are switched on the basis of a change of the operating position of an ignition switch (hereinafter, I/G switch) 61.

The electronic control unit 60 is configured to include a memory (volatile memory and nonvolatile memory) that stores programs and computation maps for executing various controls, various pieces of data calculated in executing control, and the like, and executes, for example, the following controls on the basis of the engine operating state, and the like, acquired from the output values of the various sensors including the sensors 51 to 57.

That is, idle speed control (hereinafter, ISC) is executed to keep the engine rotation speed NE at a predetermined idle rotation speed during idle operation of the internal combustion engine 10. In addition, air-fuel ratio feedback control is executed over the fuel injection amount in order to bring the actual air-fuel ratio detected by the air-fuel ratio sensor 56 into coincidence with the target air-fuel ratio (for example, stoichiometric air-fuel ratio).

In addition, normally, the voltage Valt generated by the alternator 70 is set at a predetermined voltage V1 (for example, 14 V). However, when the state of charge of the battery 80 is higher than or equal to a predetermined value, the following charging control is executed. That is, in charging control, in order to reduce fuel consumption by reducing power generation load, the voltage Valt generated by the alternator 70 is set at a predetermined voltage V2 (for example, 12 V) lower than the normal generated voltage V1 (V2<V1).

Incidentally, an abnormality of some kind may occur in a fuel injection system formed of the fuel injection valve 14, a high-pressure pump (not shown) that supplies high-pressure fuel to the fuel injection valve 14 and a relief mechanism (not shown) that relieves redundant fuel to thereby cause the actual injection amount that is the amount of fuel actually injected and supplied significantly exceeds the target injection amount. In this case, the actual air-fuel ratio is richer than the target air-fuel ratio, which may lead to deterioration, or the like, of exhaust gas property.

Then, in the present embodiment, at the time of executing air-fuel ratio feedback control, it is diagnosed that a rich abnormality that the air-fuel ratio of air-fuel mixture is excessively rich is occurring in the fuel injection system as follows. That is, the air-fuel ratio correction amount is monitored, and, when the air-fuel ratio correction amount reduces to below a predetermined determination value, it is determined that the actual injection amount is unnecessarily large with respect to the target injection amount, and it is diagnosed that a rich abnormality is occurring. Note that this diagnostic manner is generally known, and the above predetermined determination value is preset through an experiment or a simulation.

Incidentally, as described above, when the engine is cold, injected fuel is hard to be atomized, so part of injected fuel may be not subjected to burning but adhere to the inner peripheral surface of the cylinder, and may be mixed with lubricating oil adhering to the inner peripheral surface of the cylinder in order to lubricate an engine piston. Then, lubricating oil on the inner peripheral surface of the cylinder, diluted through mixing of fuel, is scraped as the engine piston moves up and down, and is returned to the crankcase 40.

Here, as the percentage of fuel mixed in the lubricating oil, that is, the degree of mixing of fuel, increases, a large amount of fuel evaporates from the lubricating oil accordingly, so the concentration of fuel in blowby gas may increase considerably. Then, as the blowby gas is returned to the intake passage 22, the actual air-fuel ratio of air-fuel mixture becomes richer than the target air-fuel ratio because of the returned blowby gas, so the air-fuel ratio correction amount in air-fuel ratio feedback control excessively reduces. As a result, although no abnormality is occurring in the fuel injection system, it may be erroneously diagnosed that a rich abnormality is occurring.

Moreover, in the present embodiment, as described above, when the state of charge of the battery 80 is higher than or equal to the predetermined value, charging control for setting the voltage Valt generated by the alternator 70 at the voltage V2 lower than the normal voltage V1 is executed. Therefore, as charging control is executed at the voltage V2 until the degree of mixing of fuel in the lubricating oil is high, power generation load reduces to reduce the engine load, so the flow rate of fresh air reduces, and the percentage of blowby gas (particularly, fuel component) in air-fuel mixture increases. Therefore, an erroneous diagnosis that the above rich abnormality is occurring further tends to be made.

Therefore, in the present embodiment, the degree D of mixing of fuel in the lubricating oil of the internal combustion engine 10 is estimated at the time of diagnosing whether a rich abnormality is occurring, and, when the state of charge of the battery 80 is higher than or equal to the predetermined value during idle operation of the internal combustion engine 10, charging control for charging the battery 80 at the voltage V2 is prohibited when the estimated degree D of mixing of fuel is higher than or equal to a predetermined degree Dth. By so doing, it is possible to suppress an erroneous diagnosis that the above described rich abnormality is occurring.

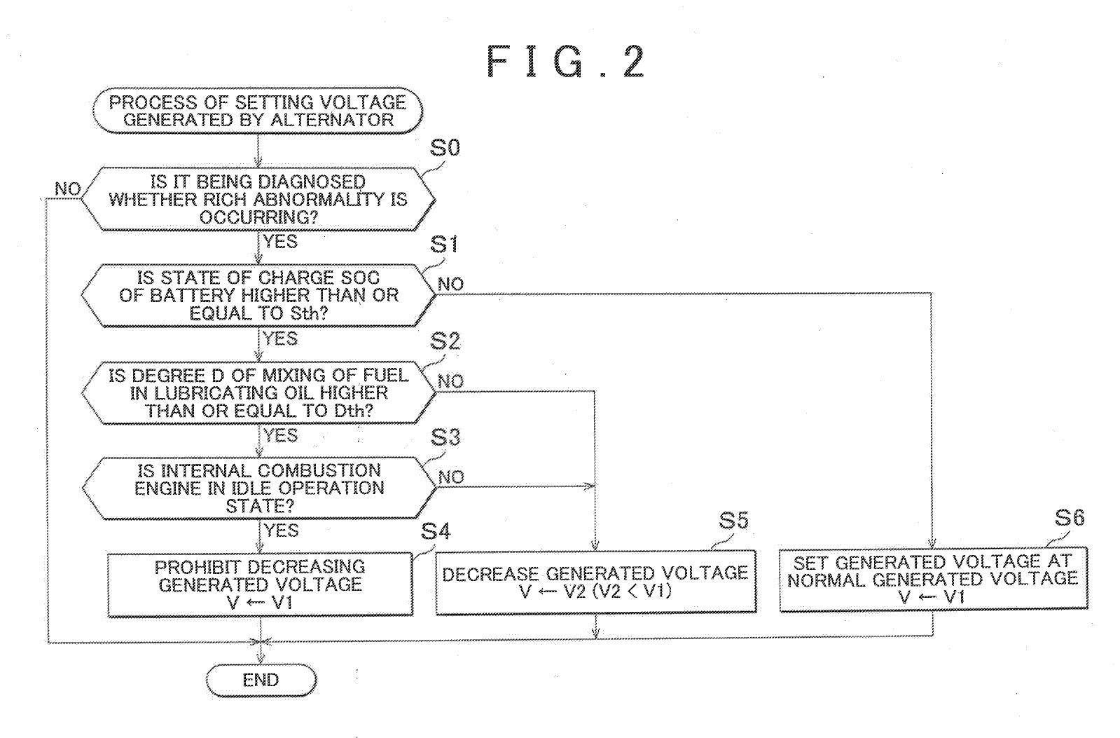

Next, the procedure of the process of setting the voltage Valt generated by the alternator 70 in the present embodiment will be described with reference to FIG. 2. Note that a series of processes shown in FIG. 2 are repeatedly executed at predetermined intervals.

In step S0, the electronic control unit 60 determines whether it is being diagnosed whether a rich abnormality is occurring. Here, when it is not being diagnosed whether a rich abnormality is occurring (“NO” in step S0), the electronic control unit 60 once ends the series of processes.

On the other hand, when it is being diagnosed in step S0 whether a rich abnormality is occurring (“YES” in step S0), the process proceeds to step S1. Note that the process of S0 is not limited to the configuration that the process of S0 is executed before S1; instead, it may be executed during the flow of the processes.

Subsequently, in step S1, the electronic control unit 60 determines whether the state of charge SOC of the battery 80 is higher than or equal to a predetermined value Sth, that is, whether it is in a state where a request to decrease the voltage Valt generated by the alternator 70 is issued. Here, when the state of charge SOC of the battery 80 is not higher than or equal to the predetermined value Sth (“NO” in step S1), the electronic control unit 60 determines that it is not the timing at which charging control for charging the battery 80 at the voltage V2 is executed, and the electronic control unit 60 sets the generated voltage Valt at the normal generated voltage V1 in step S6, and then once ends the series of processes.

On the other hand, when the state of charge SOC of the battery 80 is higher than or equal to the predetermined value Sth in step S1 (“YES” in step S1), the process proceeds to step S2. In step S2, the electronic control unit 60 determines whether the estimated degree D of mixing of fuel in the lubricating oil is higher than or equal to the predetermined degree Dth. Note that, in the present embodiment, the degree D of mixing of fuel is estimated in a generally known manner on the basis of the operation history (coolant temperature THW, fuel injection amount, and the like) of the internal combustion engine 10. That is, the fuel injection amount is accumulated when the engine is cold, that is, when the coolant temperature THW is low, and the degree D of mixing of fuel is calculated on the basis of the accumulated value.

Here, when the estimated degree D of mixing of fuel is higher than or equal to the predetermined degree Dth (“YES” in step S2), the electronic control unit 60 determines in step S3 whether the internal combustion engine 10 is in an idle operation state. As a result, when the internal combustion engine 10 is in the idle operation state (“YES” in step S3), the electronic control unit 60 prohibits decreasing the generated voltage Valt, that is, sets the generated voltage Valt at the normal generated voltage V1, in step S4, and then once ends the series of processes.

On the other hand, when the estimated degree D of mixing of fuel is not higher than or equal to the predetermined degree Dth (“NO” in step S2) or when the internal combustion engine 10 is not in the idle operation state (“NO” in step S3), the electronic control unit 60 determines that it is the timing at which charging control for charging the battery 80 at the voltage V2 is executed, and then the process proceeds to step S5. In step S5, the electronic control unit 60 sets the generated voltage Valt at the generated voltage V2 (<V1) lower than the normal generated voltage Valt, and then once ends the series of processes.

Here, the predetermined degree Dth is set at the minimum value of the degree D of mixing of fuel at which an erroneous diagnosis that the rich abnormality is occurring may be made when the voltage Valt generated by the alternator 70 is set at the voltage V2 at the time of charging control for charging the battery 80 at the voltage V2 during idle operation of the internal combustion engine 10, and is preset through an experiment, or the like.

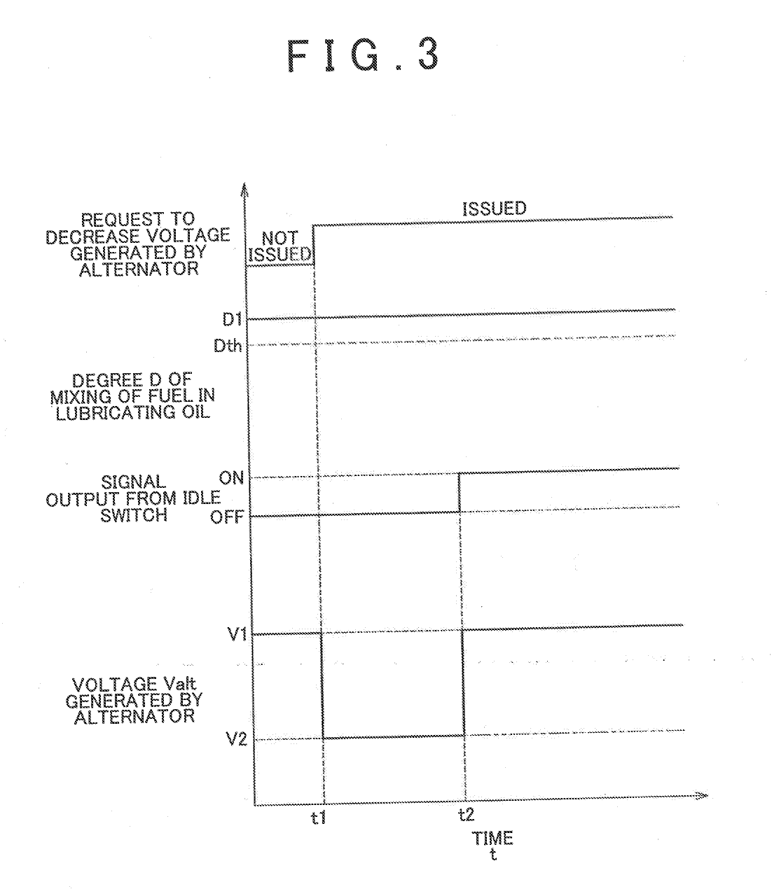

Next, the operation of the present embodiment will be described with reference to FIG. 3. Note that FIG. 3 shows examples of changes of whether there is a request to decrease the voltage generated by the alternator 70, the degree D of mixing of fuel in the lubricating oil, the signal output from the idle switch 57 and the voltage Valt generated by the alternator 70 together.

As shown in FIG. 3, for example, in a state where the degree D of mixing of fuel in the lubricating oil is higher than the predetermined degree D during intermediate load operation of the internal combustion engine, a request to decrease the voltage generated by the alternator 70 is issued on the basis of the state of charge SOC of the battery 80 at time t1. Accordingly, the voltage Valt generated by the alternator 70 is decreased from the normal generated voltage V1 to the predetermined voltage V2.

Then, in this state, at time t2, the internal combustion engine 10 enters the idle operation state, and the idle switch 57 is changed from the “OFF” state to the “ON” state. In this case, although a request to decrease the voltage generated by the alternator 70 is issued on the basis of the state of charge SOC of the battery 80, the generated voltage Valt is returned from the voltage V2 till then to the normal generated voltage V1. That is, decreasing the generated voltage Valt is prohibited.

In contrast to this, when general charging control is executed, as indicated by the alternate long and two short dashes line in FIG. 3, the generated voltage Valt is kept at the predetermined voltage V2 after time t2 as well. With the above described internal combustion engine control device according to the present embodiment, the following operations and advantageous effects may be obtained.

(1) The electronic control unit 60 is applied to the internal combustion engine 10 that includes the engine-driven alternator 70, and diagnoses on the basis of the air-fuel ratio correction amount in air-fuel ratio feedback control whether a rich abnormality that the air-fuel ratio of air-fuel mixture is excessively rich is occurring in the fuel injection system. In addition, when the state of charge SOC of the battery 80 charged with electric power generated by the alternator 70 is higher than or equal to the predetermined value, charging control for setting the voltage Valt generated by the alternator 70 at the voltage V2 lower than the normal generated voltage V1 is executed. In addition, the degree D of mixing of fuel in the lubricating oil of the internal combustion engine 10 is estimated, and, when the state of charge SOC of the battery 80 is higher than or equal to the predetermined value, charging control for charging the battery 80 at the voltage V2 is prohibited when the estimated degree D of mixing of fuel is higher than or equal to the predetermined degree Dth.

In the internal combustion engine 10, as the degree D of mixing of fuel in the lubricating oil increases, the fuel concentration in blowby gas returned to the intake passage 22 increases, and such blowby gas is returned to the intake passage 22 to further enrich the air-fuel ratio of air-fuel mixture. In addition, the flow rate of blowby gas returned to the intake passage 22 almost does not vary even when the flow rate of fresh air varies. With these facts, as the degree D of mixing of fuel in the lubricating oil increases or as the flow rate of fresh air reduces, the percentage of blowby gas (particularly, fuel component) in air-fuel mixture increases, and an erroneous diagnosis that a rich abnormality is occurring in the fuel injection system tends to be made because of dilution of lubricating oil due to mixing of fuel.

According to the above embodiment, when the state of charge SOC of the battery 80 is higher than or equal to the predetermined value, the voltage Valt generated by the alternator 70 is set at the generated voltage V2 lower than the normal generated voltage V1 (V2<V1), so the power generation load is reduced to reduce the engine load to thereby make it possible to save power consumption. In addition, even when the state of charge SOC of the battery 80 is higher than or equal to the predetermined value, but when the estimated degree D of mixing of fuel is higher than or equal to the predetermined degree Dth, charging control for charging the battery 80 at the voltage V2 is prohibited. Therefore, the engine load is not reduced, a reduction in the flow rate of fresh air is avoided, and an increase in the percentage of blowby gas (particularly, fuel component) in air-fuel mixture is avoided. Here, in the configuration that the flow rate of fresh air is simply increased, engine output increases and the increased engine output is converted to an increase in the engine rotation speed NE, so the driver may experience a feeling of strangeness. However, according to the present embodiment, even when engine output increases, the increased engine output is converted to electric power by driving the alternator 70, so the driver is hard to experience a feeling of strangeness. Thus, while suppressing a feeling of strangeness experienced by the driver, by adequately limiting charging control for charging the battery 80 at the voltage V2, it is possible to suppress an erroneous diagnosis that a rich abnormality is occurring in the fuel injection system because of dilution of lubricating oil due to mixing of fuel.

(2) On the condition that the internal combustion engine 10 is in idle operation, when the estimated degree D of mixing of fuel is higher than or equal to the predetermined degree Dth, the process of prohibiting charging control for charging the battery 80 at the voltage V2 is executed. With the above configuration, only during idle operation in which an erroneous diagnosis that a rich abnormality is occurring in the fuel injection system because of dilution of lubricating oil due to mixing of fuel tends to be made, the process of prohibiting charging control for charging the battery 80 at the voltage V2 is executed. Therefore, it is possible to suppress an erroneous diagnosis that the rich abnormality is occurring during idle operation of the internal combustion engine 10. In addition, during high load operation, or the like, of the internal combustion engine 10, in which an erroneous diagnosis that the rich abnormality is occurring is hard to be made, the voltage Valt generated by the alternator 70 is not set so as to be unnecessarily high. Thus, it is possible to suppress an unnecessary increase in power generation load caused by the alternator 70, so deterioration of fuel consumption may be suppressed.

### Second Embodiment

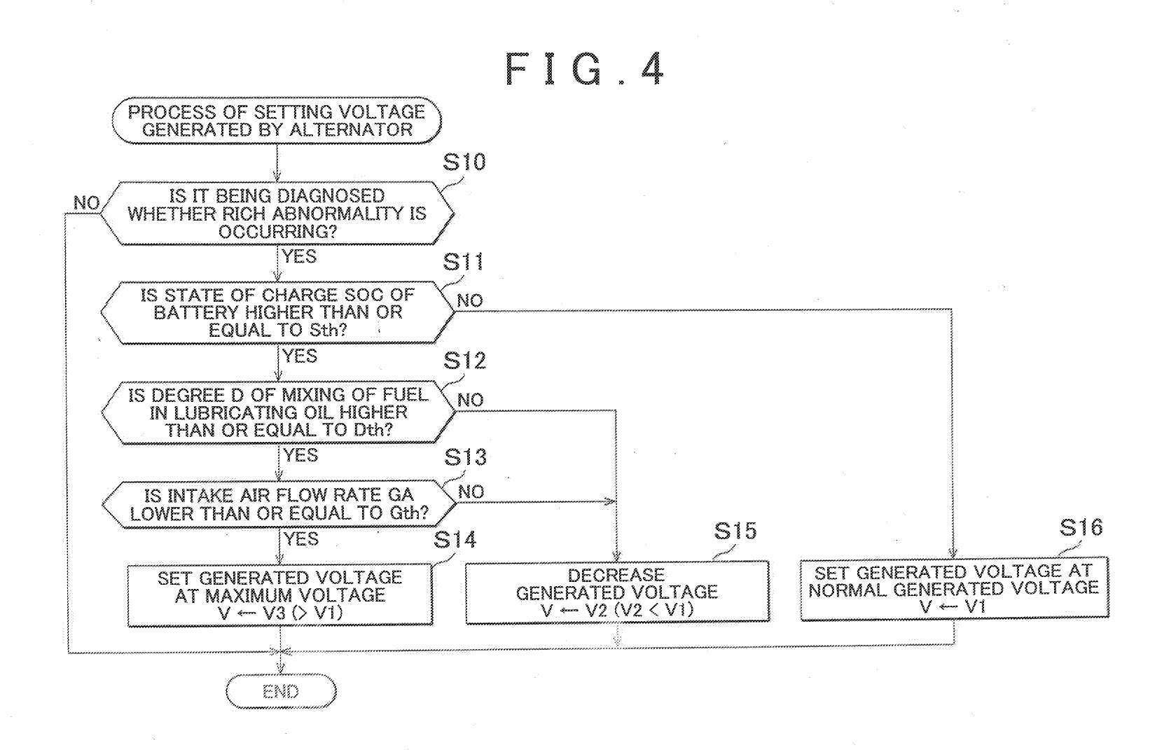

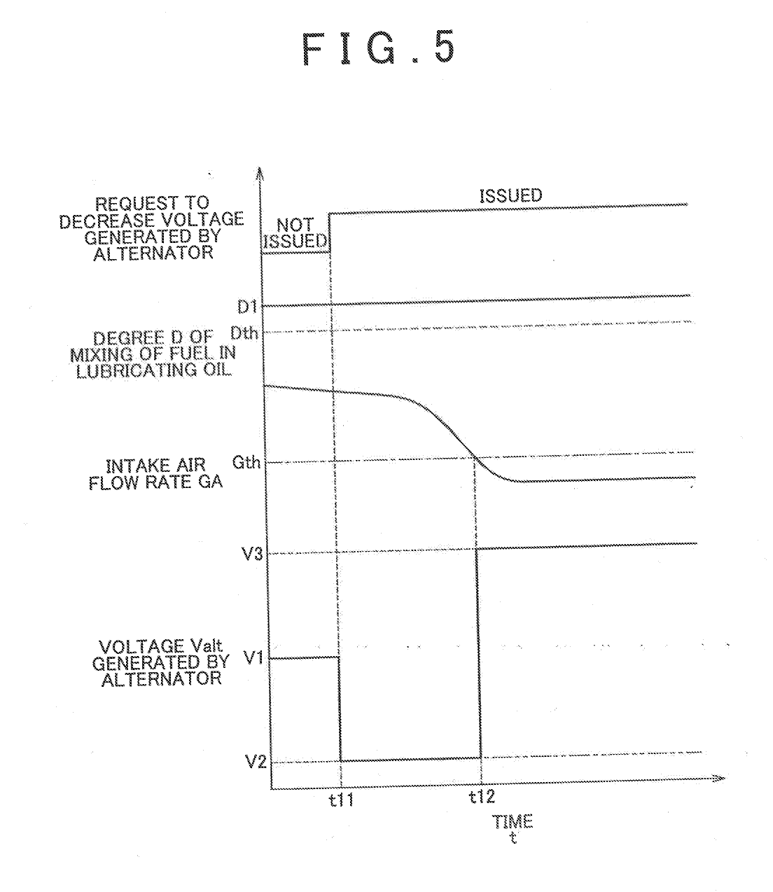

An internal combustion engine control device according to a second embodiment of the invention will be described with reference to FIG. 4 and FIG. 5.

The present embodiment is the same as the first embodiment in that, when the state of charge SOC of the battery 80 is higher than or equal to the predetermined value, charging control for charging the battery 80 at the voltage V2 is prohibited when the estimated degree D of mixing of fuel is higher than or equal to the predetermined degree Dth. However, the present embodiment differs from the first embodiment in that the voltage Valt generated by the alternator 70 is set at a maximum value V3 (for example, 16 V) within a settable range. Note that the other configuration is basically the same as that of the first embodiment, so the overlap description is omitted below.

Next, the procedure of the process of setting the voltage generated by the alternator 70 in the present embodiment will be described with reference to FIG. 4. Note that a series of processes shown in FIG. 4 are repeatedly executed at predetermined intervals.

In step S10, the electronic control unit 60 determines whether it is being diagnosed whether a rich abnormality is occurring. Here, when it is not being diagnosed whether a rich abnormality is occurring (“NO” in step S10), the electronic control unit 60 once ends the series of processes.

On the other hand, when it is being diagnosed in step S10 whether a rich abnormality is occurring (“YES” in step S10), the process proceeds to step S11. Note that the process of S10 is not limited to the configuration that the process of S10 is executed before S11; instead, it may be executed during the flow of the processes.

Subsequently, the electronic control unit 60 determines whether the state of charge SOC of the battery 80 is higher than or equal to the predetermined value Sth (step S11). Here, when the state of charge SOC of the battery 80 is not higher than or equal to the predetermined value Sth (“NO” in step S11), the electronic control unit 60 sets the generated voltage Valt at the normal generated voltage V1 (step S16), and then once ends the series of processes.

On the other hand, when the state of charge SOC of the battery 80 is higher than or equal to the predetermined value Sth (“YES” in step S11), the electronic control unit 60 determines whether the estimated degree D of mixing of fuel in the lubricating oil is higher than or equal to the predetermined degree Dth (step S12). Here, when the estimated degree D of mixing of fuel is higher than or equal to the predetermined degree Dth (“YES” in step S12), the electronic control unit 60 determines in step S13 whether the intake air flow rate GA is smaller than or equal to a predetermined flow rate Gth, that is, a low intake air flow rate. As a result, when the intake air flow rate GA is smaller than or equal to the predetermined flow rate Gth (“YES” in step S13), the electronic control unit 60 prohibits decreasing the generated voltage Valt and sets the generated voltage Valt at the maximum voltage V3 (>V1) within the settable range in step S14, and then once ends the series of processes.

On the other hand, when the estimated degree D of mixing of fuel is not higher than or equal to the predetermined degree Dth (“NO” in step S12) or when the intake air flow rate GA is not smaller than or equal to the predetermined flow rate Gth (“NO” in step S13), the electronic control unit 60 sets the generated voltage Valt at the generated voltage V2 (<V1) lower than the normal generated voltage V1, and then once ends the series of processes.

Next, the operation of the present embodiment will be described with reference to FIG. 5. Note that FIG. 5 shows examples of changes of whether there is a request to decrease the voltage generated by the alternator 70, the degree D of mixing of fuel in the lubricating oil, the intake air flow rate GA and the voltage Valt generated by the alternator 70 together.

As shown in FIG. 5, for example, in a state where the degree D of mixing of fuel in the lubricating oil is higher than the predetermined degree D during intermediate load operation of the internal combustion engine, a request to decrease the voltage generated by the alternator 70 is issued on the basis of the state of charge SOC of the battery 80 at time t11. Accordingly, the voltage Valt generated by the alternator 70 is decreased from the normal generated voltage V1 to the predetermined voltage V2.

Then, in this state, at time t12, as the intake air flow rate GA reduces to at or below the predetermined flow rate Gth, although a request to decrease the voltage Valt generated by the alternator 70 is issued on the basis of the state of charge SOC of the battery 80, the generated voltage Valt is increased from the voltage V2 till then to the maximum voltage V3.

On the other hand, when general charging control is executed, as indicated by the alternate long and two short dashes line in FIG. 5, the generated voltage Valt is kept at the predetermined voltage V2 after time t2 as well. With the above described internal combustion engine control device according to the present embodiment, in addition to the operations and advantageous effects (1) and (2) of the first embodiment, the following operations and advantageous effects may be obtained.

(3) When the state of charge SOC of the battery 80 is higher than or equal to the predetermined value, charging control for charging the battery 80 at the voltage V2 is prohibited when the estimated degree-D of mixing of fuel is higher than or equal to the predetermined degree Dth, and the voltage Valt generated by the alternator 70 is set at the maximum value V3 (>V1) within the settable range. According to the present embodiment, the power generation load is maximized to maximize the amount of increase in engine load caused by driving the alternator 70, so the flow rate of fresh air further increases. By so doing, the percentage of blowby gas (particularly, fuel component) in air-fuel mixture further reduces. Thus, it is possible to further suppress an erroneous diagnosis that a rich abnormality is occurring.

Note that the internal combustion engine control device according to the aspect of the invention is not limited to the configuration illustrated in the above embodiments; however, it may be implemented in, for example, the following alternative embodiments modified from the above embodiments where appropriate.

In the above described embodiments, the mechanical PCV valve 36 is illustrated; instead, an electric PCV valve may be employed. In this case as well, as long as the flow rate of blowby gas returned to the intake passage 22 almost does not vary irrespective of the flow rate of fresh air, there is the above described problem similarly. Thus, even with such a configuration, control illustrated in the above described embodiments is executed to thereby make it possible to obtain operations and advantageous effects similar to the above described operations and advantageous effects (1) to (3).

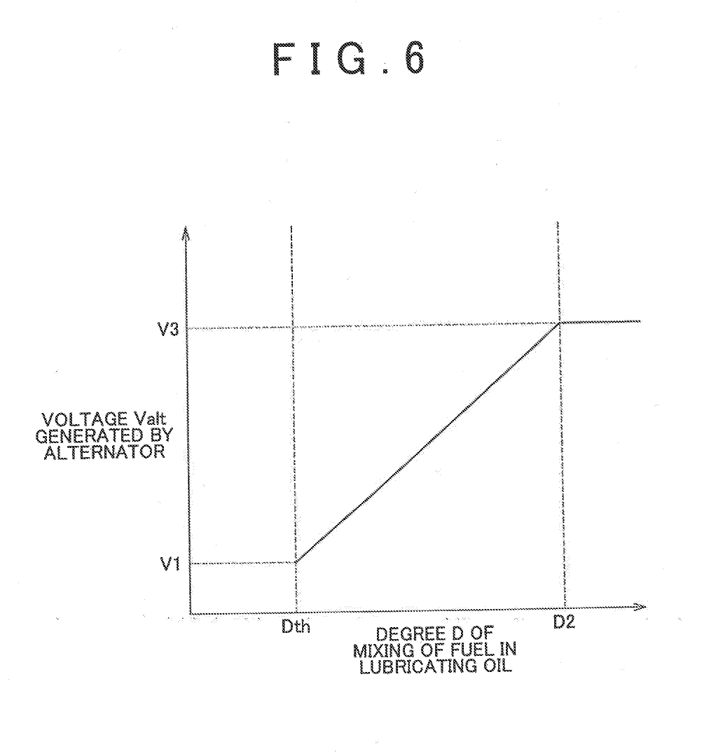

In the above described embodiments, when the state of charge SOC of the battery 80 is higher than or equal to the predetermined value, charging control for charging the battery 80 at the voltage V2 is prohibited when the estimated degree D of mixing of fuel is higher than or equal to the predetermined degree Dth, and the voltage Valt generated by the alternator 70 is set at the normal generated voltage V1 or the maximum voltage V3. However, the aspect of the invention is not limited to the configuration that the voltage Valt generated by the alternator 70 is set at the predetermined voltage V1 (or V3) (fixed value). Other than the above, for example, as shown in FIG. 6, when the estimated degree D of mixing of fuel is higher than or equal to the predetermined degree Dth, the voltage Valt generated by the alternator 70 may be set so as to be higher as the degree D of mixing of fuel increases. In this case, as the probability of making an erroneous diagnosis that a rich abnormality is occurring because of the degree D of mixing of fuel in the lubricating oil increases, the power generation load is increased to increase the engine load. By so doing, as the probability of making an erroneous diagnosis that the rich abnormality is occurring increases, the influence of blowby gas (particularly, fuel component) may be reduced. In addition, in this case, the voltage Valt generated by the alternator 70 may be set through feedforward control. By so doing, the voltage Valt generated by the alternator 70 may be easily set at an appropriate value corresponding to the degree D of mixing of fuel. In addition, in this case, even when the degree D of mixing of fuel is slightly lower than the predetermined degree Dth, the voltage Valt generated by the alternator 70 may be variably set on the basis of the degree D of mixing of fuel.

In the above embodiments, when the idle switch 57 is in the “ON” state, that is, during idle operation of the internal combustion engine 10 (first embodiment) or when the intake air flow rate GA is smaller than or equal to the predetermined flow rate Gth (second embodiment), it is determined that the internal combustion engine 10 is in low load operation. However, a method of determining whether the internal combustion engine 10 is in low load operation is not limited to this configuration; it is applicable that an engine load rate KL is calculated and then it is determined that the internal combustion engine 10 is in low load operation when the engine load rate KL is lower than or equal to a predetermined value.

In the above second embodiment, when the state of charge SOC of the battery 80 is higher than or equal to the predetermined value, charging control for charging the battery 80 at the voltage V2 is prohibited and the voltage Valt generated by the alternator 70 is set at the maximum voltage V3 when the estimated degree D of mixing of fuel is higher than or equal to the predetermined degree Dth. Instead, the voltage Valt generated by the alternator 70 may be set at a predetermined generated voltage V4 (V1<V4<V3) that is higher than the normal generated voltage V1 and is lower than the maximum voltage V3.

In the above first embodiment, when the state of charge SOC of the battery 80 is higher than or equal to the predetermined value, charging control for charging the battery 80 at the voltage V2 is prohibited when the estimated degree D of mixing of fuel is higher than or equal to the predetermined degree Dth. Instead, the voltage Valt generated by the alternator 70 may be set at a predetermined generated voltage V5 (V2<V5<V1) that is lower than the normal generated voltage V1 and is higher than the predetermined voltage V2. That is, it is only necessary that, when the state of charge of the battery 80 is higher than or equal to the predetermined value, charging control for charging the battery 80 at the voltage V2 is limited when the estimated degree D of mixing of fuel is higher than or equal to the predetermined degree Dth.

In the above described embodiments, the degree D of mixing of fuel is estimated on the basis of the operation history (coolant temperature THW, fuel injection amount, and the like) of the internal combustion engine 10. However, the aspect of the invention is not limited to the configuration that the degree D of mixing of fuel is actually estimated (calculated). Other than that, for example, it may be determined that the degree of mixing of fuel is higher than or equal to the predetermined degree when the duration of idle operation has reached a predetermined period of time in a state where the engine is cold, that is, when the engine temperature (coolant temperature THW, the temperature of lubricating oil) is lower than or equal to a predetermined temperature.

The aspect of the invention is not limited to the configuration that charging control for charging the battery 80 at the voltage V2 is executed. Even when charging control for charging the battery 80 at the voltage V2 is not executed, the voltage generated by a generator may be set so as to be higher when the degree of mixing of fuel is higher than or equal to the predetermined degree than when the degree of mixing of fuel is not higher than or equal to the predetermined degree. This may suppress an erroneous diagnosis that a rich abnormality is occurring in the fuel injection system because of dilution of lubricating oil due to mixing of fuel while suppressing a feeling of strangeness experienced by the driver.

What is claimed is:

1. An internal combustion engine control device that is applied to an internal combustion engine that includes an engine-driven generator, comprising:
a controller configured to diagnose on the basis of an air-fuel ratio correction amount in air-fuel ratio feedback control whether a rich abnormality that an air-fuel ratio of air-fuel mixture is excessively rich is occurring in a fuel injection system, the controller being configured to determine the degree of mixing of fuel in the lubricating oil of the internal combustion engine, the controller being configured to set a voltage generated by the generator so as to be higher when the degree of mixing of fuel is higher than or equal to a predetermined degree than when the degree of mixing of fuel is lower than the predetermined degree, the controller being configured to control the voltage generated by the generator at the time when rich abnormality determination is being carried out, the controller being configured to execute charging control for setting the voltage generated by the generator at a voltage lower than a normal generated voltage when a state of charge of a battery charged with electric power generated by the generator is higher than or equal to a predetermined value, and the controller being configured to set the voltage generated by the generator at the normal generated voltage when the state of charge of the battery is higher than or equal to the predetermined value and the degree of mixing of fuel is higher than or equal to the predetermined degree.

2. (canceled)

3. (canceled)

4. (canceled)

5. (canceled)

6. (canceled)

7. (canceled)

8. The internal combustion engine control device according to claim 1, wherein, on the condition that the internal combustion engine is in a predetermined low load operation, the controller is configured to set the voltage generated by the generator so as to be higher when the degree of mixing of fuel is higher than or equal to the predetermined degree than when the degree of mixing of fuel is lower than the predetermined degree.

9. The internal combustion engine control device according to claim 8, wherein the internal combustion engine is in the predetermined low load operation when the internal combustion engine is in idle operation.

10. The internal combustion engine control device according to claim 8, wherein the internal combustion engine is in the predetermined low load operation when an intake air flow rate of the internal combustion engine is smaller than or equal to a predetermined flow rate.

11. The internal combustion engine control device according to claim 1, wherein, when the degree of mixing of fuel in the lubricating oil of the internal combustion engine is higher than or equal to the predetermined degree, the controller is configured to set the voltage generated by the generator so as to be higher as the degree of mixing of fuel increases.

12. An internal combustion engine control device that is applied to an internal combustion engine that includes an engine-driven generator, comprising:
a controller configured to diagnose on the basis of an air-fuel ratio correction amount in air-fuel ratio feedback control whether a rich abnormality that an air-fuel ratio of air-fuel mixture is excessively rich is occurring in a fuel injection system, the controller being configured to determine the degree of mixing of fuel in the lubricating oil of the internal combustion engine, the controller being configured to set, when the degree of mixing of fuel is higher than or equal to a predetermined degree, a voltage generated by the generator so as to be higher as the degree of mixing of fuel increases, and the controller being configured to control the voltage generated by the generator at the time when rich abnormality determination is being carried out, the controller being configured to execute charging control for setting the voltage generated by the generator at a voltage lower than a normal generated voltage when a state of charge of a battery charged with electric power generated by the generator is higher than or equal to a predetermined value, and the controller being configured to set the voltage generated by the generator at the normal generated voltage when the state of charge of the battery is higher than or equal to the predetermined value and the degree of mixing of fuel is higher than or equal to the predetermined degree.

13. (canceled)

14. The internal combustion engine control device according to claim 12, wherein, on the condition that the internal combustion engine is in a predetermined low load operation, the power generation controller is configured to set the voltage generated by the generator so as to be higher as the degree of mixing of fuel increases when the degree of mixing of fuel is higher than or equal to the predetermined degree.

15. The internal combustion engine control device according to claim 14, wherein the internal combustion engine is in the predetermined low load operation when the internal combustion engine is in idle operation.

16. The internal combustion engine control device according to claim 14, wherein the internal combustion engine is in the predetermined low load operation when an intake air flow rate of the internal combustion engine is smaller than or equal to a predetermined flow rate.

17. The internal combustion engine control device according to claim 1, wherein the voltage generated by the generator is set through feedforward control.

18. An internal combustion engine control method that is applied to an internal combustion engine that includes an engine-driven generator, comprising:
diagnosing on the basis of an air-fuel ratio correction amount in air-fuel ratio feedback control whether a rich abnormality that an air-fuel ratio of air-fuel mixture is excessively rich is occurring in a fuel injection system;
determining a degree of mixing of fuel in lubricating oil of the internal combustion engine;
setting, at the time when rich abnormality determination is being carried out, a voltage generated by the generator so as to be higher when the degree of mixing of fuel is higher than or equal to a predetermined degree than when the degree of mixing of fuel is lower than the predetermined degree;
setting, at the time when rich abnormality determination is being carried out, the voltage generated by the generator at a voltage lower than a normal generated voltage when a state of charge of a battery charged with electric power generated by the generator is higher than or equal to a predetermined value; and
setting, at the time when rich abnormality determination is being carried out, the voltage generated by the generator at the normal generated voltage when the state of charge of the battery is higher than or equal to the predetermined value and the degree of mixing of fuel is higher than or equal to the predetermined degree.

19. An internal combustion engine control method that is applied to an internal combustion engine that includes an engine-driven generator, comprising:
diagnosing on the basis of an air-fuel ratio correction amount in air-fuel ratio feedback control whether a rich abnormality that an air-fuel ratio of air-fuel mixture is excessively rich is occurring in a fuel injection system;
determining a degree of mixing of fuel in lubricating oil of the internal combustion engine;
setting, at the time when rich abnormality determination is being carried out, a voltage generated by the generator so as to be higher as the degree of mixing of fuel increases, when the degree of mixing of fuel is higher than or equal to a predetermined degree
setting, at the time when rich abnormality determination is being carried out, the voltage generated by the generator at a voltage lower than a normal generated voltage when a state of charge of a battery charged with electric power generated by the generator is higher than or equal to a predetermined value; and
setting, at the time when rich abnormality determination is being carried out, the voltage generated by the generator at the normal generated voltage when the state of charge of the battery is higher than or equal to the predetermined value and the degree of mixing of fuel is higher than or equal to the predetermined degree.
